(19) United States
(12) Patent Application Publication
(10) Pub. No.: US 2008/0023940 A1
(43) Pub. Date: Jan. 31, 2008

(54) Unitary trailer hitch safety device

(76) Inventor: Eley Coy Warford, Santa Fe, TX (US)

Correspondence Address: JAMES D. MANNIX, 8324 PANORAMA RIDGE COURT, SPRING VALLEY, CA, 92077, US

(21) Appl. No.: 11/484,102

(22) Filed: Jul. 11, 2006

(51) Int. Cl. B60D 1/60

(52) U.S. Cl. 280/507

(57) ABSTRACT

A unitary compact trailer hitch safety device for use on a vehicle with a trailer ball and ball receiver type connection between a vehicle and a trailer. The unitary compact trailer hitch safety device includes a “z” shaped arrestor plate fixed to vehicle's draw bar; a stop plate is pivotally fixed to the upper region of the “z” shaped arrestor plate to swing a bulbous end region of the stop plate over the trailer ball coupled to a ball receiver. A pinning assembly positioned below the upper region of the “z” shaped arrestor plate facing the vehicle is protected by the arrestor plate from ball receiver strikes during coupling to or uncoupling from the trailer ball. The pinning assembly releaseably fixes the bulbous end region of the stop plate over the ball and receiver to prevent uncoupling.

### BACKGROUND OF THE INVENTION

1. Field of the Invention

The present invention relates to ball and receiver type trailer hitches and particularly to a safety device for preventing the decoupling of the ball and receiver members.

2. Description of the Related Art

Trailers are typically used for towing any of a number of items, such as boats, recreational vehicles, camping trailers, low boys and the like. Presently, trailers are coupled to a vehicle via a draw bar with a ball and the trailer with a receiver. In general, the trailer has a forward tongue to which a ball receiver is attached thereto. The ball and receiver interface enables a flexible yet typically strong connection between the vehicle and trailer.

However, a bad coupling between the ball and receiver can result in a decoupling and loss of control over the trailer and/or vehicle. Typically, safety chains are required to at least keep the trailer connected to the vehicle, if such a decoupling has occurred. However, such safety chains are designed to do nothing more than keep the moving vehicle and trailer somewhat connected until the two can be stopped and reconnected.

Furthermore, there is always the problem of connecting the receiver to the ball. Typically the receiver (and trailer) is pulled towards the ball. Proper alignment is critical to the coupling of the receiver to the ball. Failure to do so may result in the receiver missing the ball and striking the vehicle and/or associated towing equipment (such as the electrical connectors or other securing means). Similar strikes can occur when uncoupling the receiver from the ball.

The prior art devices have not adequately addressed the problem of providing a unitary and compact coupling safety device to prevent a ball receiver from uncoupling from a ball and further protect the safety device's locking or pivoting mechanisms from damage while coupling (or uncoupling) the hitch receiver to (from) the ball. The prior art set forth in Table 1 reveal two piece devices.

TABLE 1

| Reference No. | Date | Inventor | Title |
|---|---|---|---|
| 3,522,958 | Aug. 4, 1970 | Lusignan | Guard for Trailer |
| | | | Hitch |
| 3,730,558 | May 1, 1973 | Litzenberger | Trailer Hitch |
| | | | Safety Device |
| 4,032,171 | Jun. 28, 1977 | Allen et al | Trailer Hitch |
| | | | Locking Device |
| 4,141,569 | Feb. 27, 1979 | Dilk | Theft Prevention |
| | | | Device |
| 5,087,064 | Feb. 11, 1992 | Guhlin | Anti-Theft and |
| | | | Safety Device for |
| | | | A Ball and Socket |
| | | | Trailer Hitch |
| 5,584,495 | Dec. 17, 1996 | Mason | Trailer Hitch |
| | | | Locking Assembly |
| 5,700,024 | Dec. 23, 1997 | Upchurch | Coupler Locking |
| | | | Device and |
| | | | Method |
| 5,873,271 | Feb. 23, 1999 | Smith | Trailer Vehicle |
| | | | Security Device |
| 6,062,583 | May 16, 2000 | Lauricella | Hitch Lock Device |
| D436,064 | Jan. 9, 2001 | Niswanger | Universal Trailer |
| | | | Lock |
| 6,406,052 | Jun. 18, 2002 | Bale | Secure Trailer |
| | | | Hitching Post |
| U52003/0205884A1 | Nov. 6, 2003 | Koy | Coupler Locking |
| | | | Device and |
| | | | Method |
| 6,666,051 | Dec. 23, 2003 | Li | Guarding Lock for |
| | | | Camping Trailer |
| 6,802,523 | Oct. 12, 2004 | Profitt | Safety Fastener |
| | | | for Ball and |
| | | | Socket Hitch |
| 6,969,085 | Nov. 29, 2005 | Causey | Safety Hold Down |
| | | | Device and Hitch |
| | | | Guide for Trailer |
| | | | Decoupling |
| | | | Prevention |

Each of the above safety devices described in Table 1 require the removal of a detachable member to either couple (or uncouple) the ball receiver from (to) the ball. Such detachable members can be lost or misplaced rendering each of the devices useless for its intended purpose. The prior art in Table 2 below describes devices, that while unitary, expose members that may cause failure of the device when struck by the ball receiver during coupling (or uncoupling).

TABLE 2

| Reference No. | Date | Inventor | Title |
|---|---|---|---|
| 3,479,057 | May 4, 1967 | Miller | Trailer Hitch |
| | | | Safety Device |
| 4,291,893 | Sep. 29, 1981 | Hansen | Coupling Guard |
| 5,433,467 | Jul. 18, 1995 | Easterwood | Trailers Tongue Hitch |
| | | | and Ball Clamp |
| 6,412,314 | Jul. 2, 2002 | Jenks | Trailer Hitch Lock |
| | | | Module |
| 6,637,765 | Oct. 28, 2003 | Barton | Towing Safety Device |

The devices described in U.S. Pat. No. 4,208,065 issued on Jun. 17, 1980 to Hansen; and U.S. Pat. No. 4,459,832 issued on Jul. 17, 1984 to Avrea et al. while protective of locking or pivoting elements, are not compact and therefore limited to use with long flat draw bars. Specifically, the devices described in U.S. Pat. Nos. 4,208,065 and 4,459,832 are not suitable to use with “z” shaped draw bars because the pivoting securing plate cannot be moved into a position that is clear of the coupling area. With a “z” shaped draw bar, the securing plate cannot be pivoted clear of the coupling area and is therefore exposed to strikes during coupling and may even prevent or at least hamper uncoupling of the ball receiver from the ball when desired by the operator.

What is needed is a unitary, compact trailer hitch safety device that protects its locking or pivoting elements from coupling (uncoupling) strikes.

### SUMMARY OF THE INVENTION

An object of the present invention is to provide a unitary compact trailer hitch safety device that protects the pivoting and locking elements from coupling (uncoupling) strikes with a “z” shaped arrestor plate. The upper horizontal section and the vertical section of the “z” shaped arrestor plate provide a region that is protected from receiver strikes during coupling and uncoupling. In this protected region is a pinning assembly that locks a pivoting securing plate over the ball. The securing plate is pivotally fixed to the upper horizontal section of the “z” shaped arrestor plate by a pivot that is located in the protected region.

A related object of the present invention is to provide a unitary compact trailer arrestor with a pivoting securing plate having a bulbous end region which arrests the ball receiver from traveling upwards to a position that would result in an uncoupling.

An advantage of the present invention is that it is easy to use. An additional advantage of the present invention is that it is relatively simple and inexpensive to fabricate.

### BRIEF DESCRIPTION OF THE DRAWINGS

These and other details of my invention will be described in connection with the accompanying drawings, which are furnished only by way of illustration and not in limitation of the invention, and in which drawings:

FIG. 1 is an elevation view of an embodiment of the present invention with the stop plate positioned over a trailer hitch ball.

FIG. 2 is an elevation view of an embodiment of the present invention with the stop plate positioned over a ball receiver coupled to a trailer hitch ball.

FIG. 3 is perspective depiction of an embodiment of the present invention with the stop plate swung clear of a trailer hitch ball.

FIG. 4 is a perspective depiction of an embodiment of the present invention with the stop plate swung clear of a ball receiver coupled to a trailer hitch ball.

FIG. 5 is a perspective depiction of an embodiment of the present invention with the stop plate positioned over a ball receiver coupled to a trailer hitch ball and further secured by a lock.

### DETAILED DESCRIPTION OF THE INVENTION

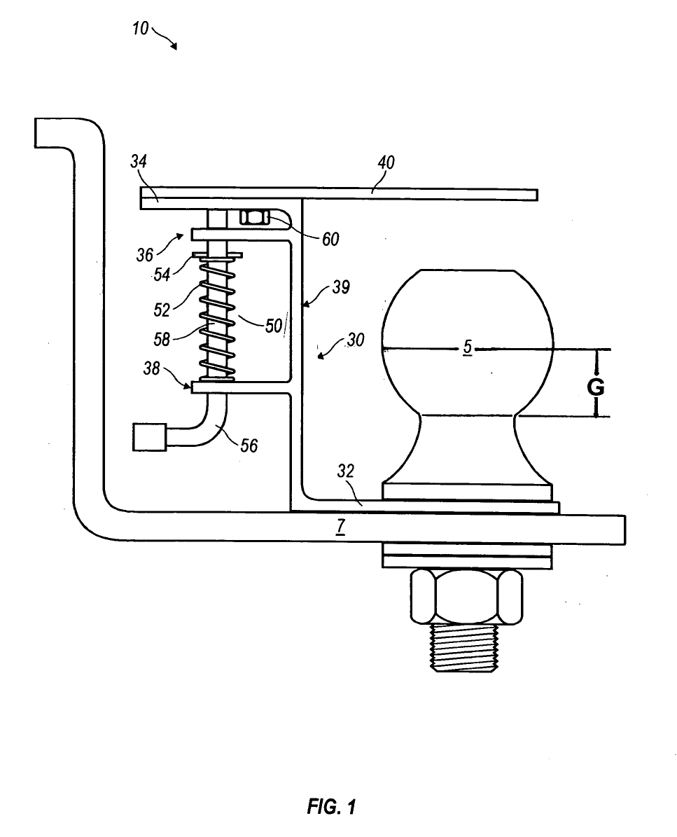

In FIGS. 1-5, a unitary compact trailer hitch safety device 10 prevents decoupling of a ball receiver 09 from a trailer ball 05.

In a stand alone preferred embodiment of the invention of FIGS. 1-5, a draw bar 07 extends rearwardly away from a towing vehicle. A trailer ball 05 is removeably fixed to a draw bar 07, the trailer ball 05 adapted for receiving a ball receiver 09. Ball receiver 09 is fixed to a trailer frame (not shown).

The preferred embodiment of the unitary compact trailer hitch arrestor 10 is an arrestor plate 30 formed in a “z” (or “s” shape) when viewed from the side. The arrestor plate 30 includes a vertical member 39 with a base plate 32 at the lower portion of the arrestor plate 30 facing the tow; and a securing plate 34 at the upper portion of the arrestor plate 30 facing the vehicle. In another embodiment, base plate 32 and securing plate 34 are welded to vertical member 39.

As shown in FIGS. 1-5, the arrestor plate 30 is removeably fixed to the draw bar 07 at the base plate 32 by trailer ball 05. It is further contemplated that arrestor plate 30 could be permanently fixed to draw bar 07.

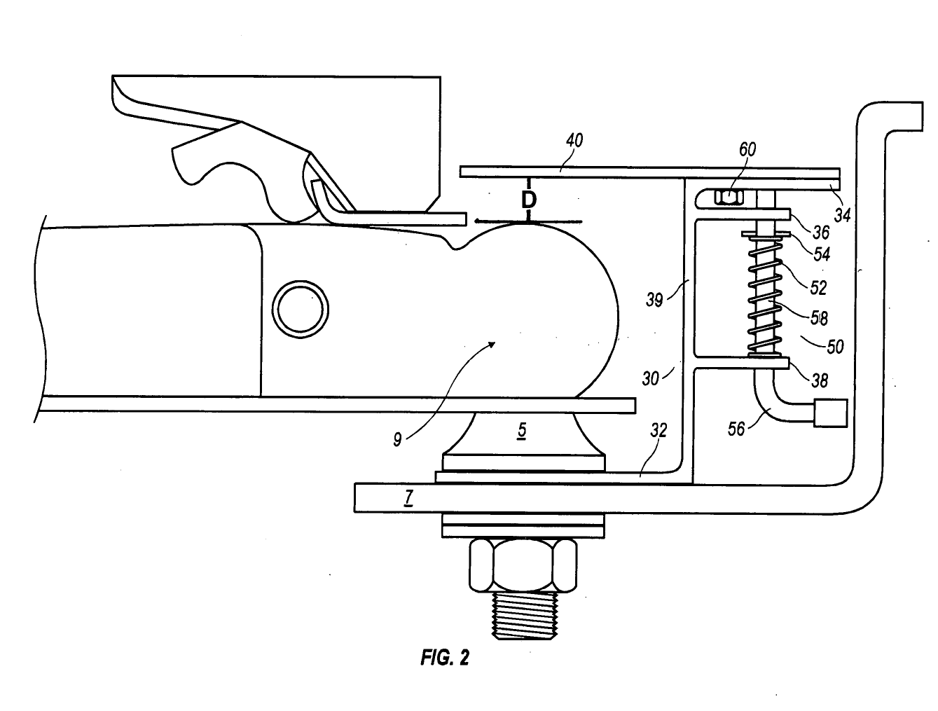

A stop plate 40 is attached by a pivot 60 (See FIGS. 1 and 2) to the securing plate 34. Pivot 60 allows stop plate 40 to swing over (and clear of) ball receiver 09 coupled to trailer ball 05. The distance D between the stop plate 40 and the coupling (of the ball receiver 09 to trailer ball 05) can vary between in contact to an air gap which is no more than the distance between the trailer ball's maximum and minimum girth G (See FIGS. 1 and 2). In a preferred embodiment, the end region 42 distal from pivot 60 is bulbous in shape to approximate the maximum diameter of trailer ball 05.

A pinning assembly 50 is fixed to the arrestor plate 30 by an upper pin guide 36 and a lower pin guide 38 (See FIGS. 1 and 2). Both pin guides 36 and 38 are fixed to the “z” shaped arrestor plate 30 below securing plate 34 and face towards the towing vehicle (See FIGS. 1 and 2). This arrangement protects the pinning assembly 50 and pivot 60 from ball receiver 09 strikes.

In a preferred embodiment, pivot 60 includes a threaded stud which projects down from stop plate 40 through a pivot hole formed in securing plate 34 and secured in place by a nut. In another embodiment, pivot 60 is a rivet which allows stop plate 40 to move about securing plate 34.

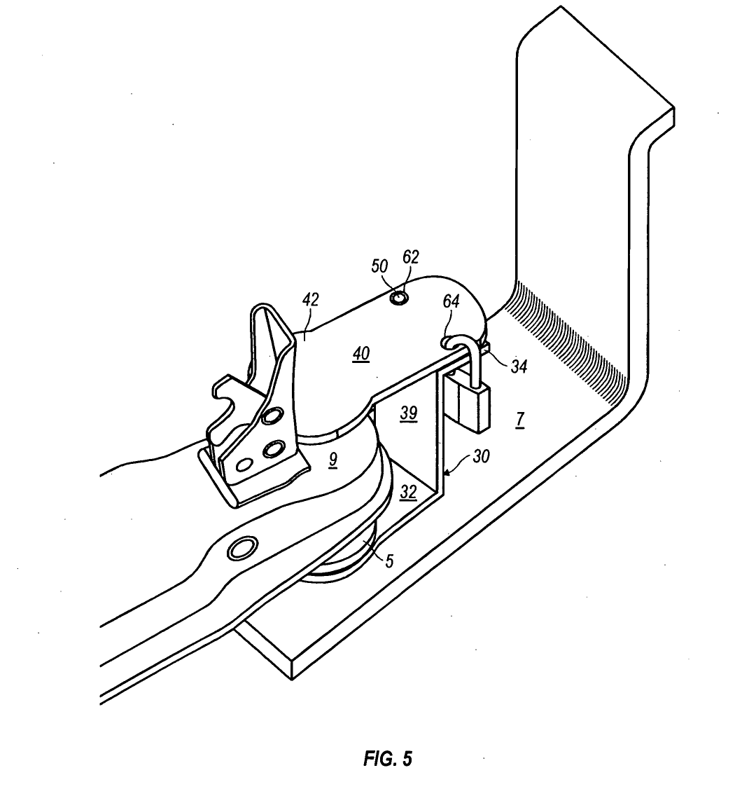

Stop plate 40 and securing plate 34 each have open securing pin holes which when aligned make a first securing pin hole set 62 that aligns stop plate 40 over the ball receiver 07 coupled to the trailer ball 05 (See FIG. 5). Pinning assembly 50 engages first securing pin hole set 62 to fix stop plate 40 over the ball receiver 07 coupled to the trailer ball 05 (See FIG. 5). In a preferred embodiment, a locking hole set 64 is formed in stop plate 40 and securing plate 34 that is aligned when stop plate 40 is over the ball receiver 70 coupled to the trailer ball 05. A lock engages locking hole set 64 to prevent movement of stop plate 40 when pinning assembly is disengaged from first securing pin hole set 62 (See FIG. 5).

In a preferred embodiment as depicted in FIGS. 1 and 2, pinning assembly 50 includes a securing pin 58 positioned inside a coil spring 52. The securing pin 50 is slideably coupled to the upper and lower pin guides 36 and 38. The coil spring 52 is compressed between the lower pin guide 38 and a spring stop bar 54 to urge the securing pin 58 upwards and through the first securing pin hole set 62 thereby fixing stop plate 40 over trailer ball 05 coupled to ball receiver 09. In a preferred embodiment, a handle 56 fixed to the end of securing pin 58 allows the operator to disengage the pinning assembly 50 and allow stop plate 40 to pivot clear of the ball receiver 09 and trailer ball 05.

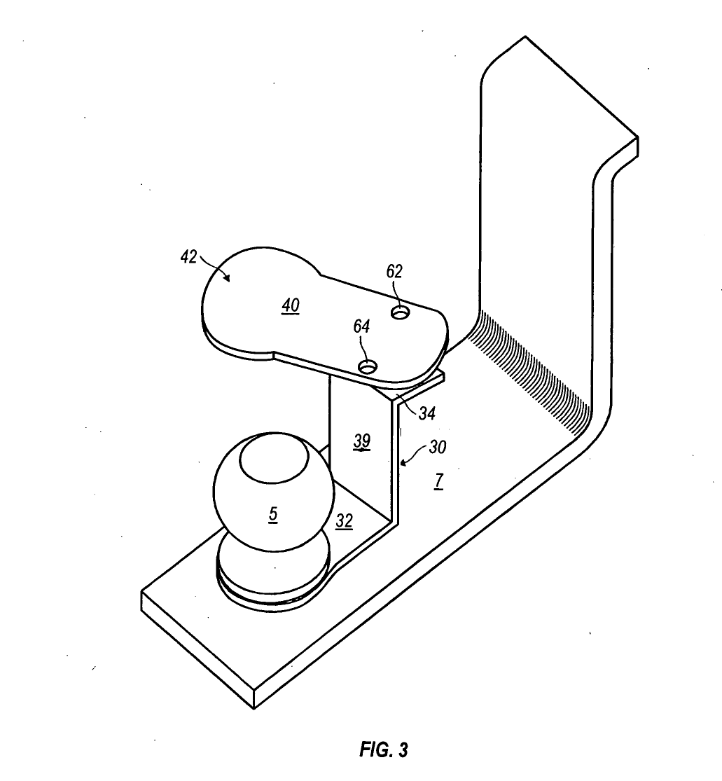

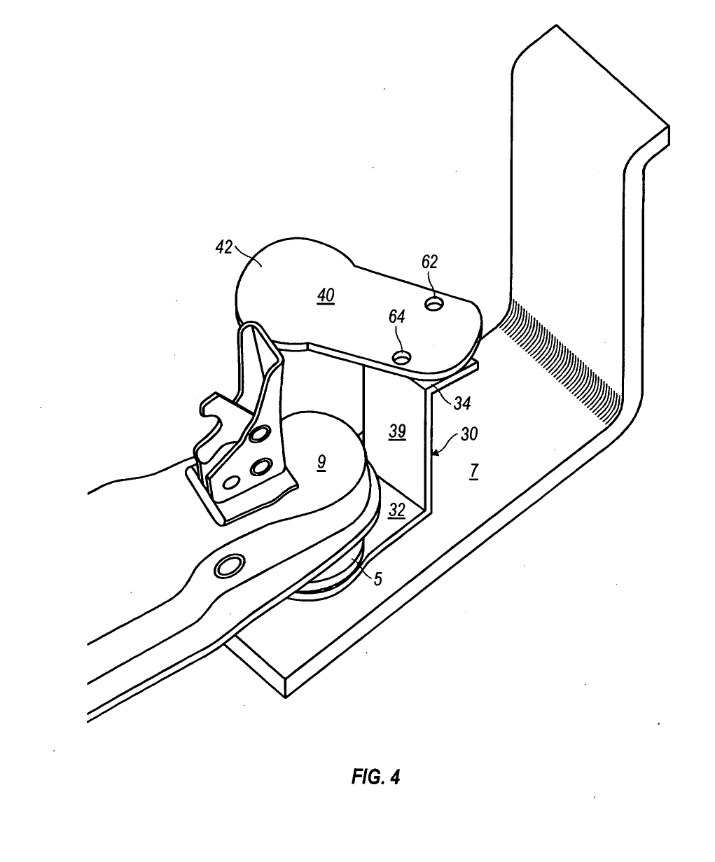

In operation, the pinning assembly 50 is disengaged momentarily to allow swinging of stop plate 40 from its locked position over the trailer ball 05 to a clear position for coupling ball receiver 09 to trailer ball 05 (See FIGS. 3 and 4). Once the ball receiver 09 is coupled to trailer ball 05, stop plate 40 can be swung back into position (See FIGS. 4 and 5). Once the first securing pin hole set 62 are aligned, securing pin 58 is urged upward by coiled spring 52 to fix stop plate 40 into position (See FIG. 5). In a preferred embodiment, a lock can be passed through a locking hole set 64 to independently lock stop plate 40 into position.

All of the components are preferably fabricated of thick hardened steel weatherproofed on the exterior to prevent rusting or stainless or other non-corroding steel.

It is understood that the preceding description is given merely by way of illustration and not in limitation of the invention and that various modifications may be made thereto without departing from the spirit of the invention as claimed.

I claim:

1. A unitary compact trailer hitch safety device for a ball receiver coupled to a trailer ball removeably mounted to a draw bar fixed to a vehicle comprising:
a base plate removeably fixed to the upper surface of the draw bar by the ball;
a substantially vertical arrestor plate with an upper end region and a lower end region, wherein said lower end region is fixed to a base plate and said upper end region is fixed to a securing plate, and said securing plate is substantially parallel to and above said base plate and extending away from said vertical arrestor plate towards the vehicle;
a substantially horizontal stop plate with a bulbous end region, wherein said stop plate is pivotally fixed to said securing plate at a location distal to said bulbous end region to allow an arcuate movement of said bulbous end region over the ball;
a securing pin hole set including a first securing pin hole, open at both ends, formed in said securing plate and a second securing pin hole, open at both ends, formed in said stop plate, wherein said first and second securing pin holes are aligned when said stop plate is positioned above the trailer ball;
an upper pin guide and a lower pin guide fixed to said arrestor plate below said securing plate;
a securing pin positioned inside a coil spring, wherein said securing pin is slideably coupled to said upper and lower pin guide and said coil spring is compressed between said lower pin guide and a spring stop fixed to said securing pin near said upper pin guide to urge said securing pin through said securing pin hole set; and

2. A unitary compact trailer hitch safety device as claimed in claim 1 wherein a locking hole set including a first locking hole, open at both ends, formed in said securing plate and a second locking hole, open at both ends, formed in said stop plate, wherein said first and second locking holes are aligned when said stop plate is positioned above the trailer ball and adapted to receive a padlock to secure said stop plate independent of said pinning assembly.

3. A unitary compact trailer hitch safety device for a ball receiver coupled to a trailer ball removeably fixed to a draw bar extending from a vehicle comprising:
an arrestor plate removeably fixed to the draw bar and extending upward away from the draw bar;
a securing plate fixed in a substantially horizontal position to an upper region of said arrestor plate and extending toward the vehicle, wherein a first open securing pin hole is formed in said securing plate;
a stop plate with a bulbous end region pivotally fixed in a substantially horizontal position to said securing plate and a second open securing pin hole is formed in said stop plate, wherein said bulbous end region is able to swing above and over the receiver coupled to the ball; and
a pinning assembly comprising a spring loaded securing pin slideably coupled to a set of upper and lower pin guides fixed to said arrestor plate and below said securing plate, wherein said arrestor plate and said securing plate shield said pinning assembly from strikes when the ball receiver is being coupled or uncoupled from the trailer ball, and said securing pin releaseably locks said bulbous end region above the receiver coupled to the ball when said securing pin is urged upward through an alignment of said first and said second securing pin holes.

4. A unitary compact trailer hitch safety device as claimed in claim 3, wherein a first open locking hole is formed in said stop plate and a second open locking hole is formed in said securing plate, wherein said first and second open locking holes, when aligned, are able to receive a lock to secure movement of said stop plate independent of said pinning assembly.

5. A unitary trailer hitch safety device comprising
a “z” shaped arrestor plate with upper and lower regions, said “z” shaped arrestor plate removeably fixed at said lower region to a draw bar that projects rearward from a vehicle;
a stop plate pivotally fixed to said upper region of said “z” shaped arrestor plate capable of swinging over a coupling between a ball receiver and a trailer ball;
a securing pin hole set formed through said upper region of said “z” shaped arrestor plate and said stop plate when said stop plate is positioned above said coupling;
a pinning assembly fixed below said upper region of said “z” shaped arrestor plate and faces said vehicle and thereby protected from damage by ball receiver strikes, wherein said pinning assembly comprises a spring loaded securing pin that releaseably locks said stop plate above said coupling when said securing pin is urged upward through said securing pin set.

6. A unitary trailer hitch safety device as claimed in claim 5, wherein a locking hole set is formed through said upper region of said “z” shaped arrestor plate and said stop plate when said stop plate is positioned above said coupling, wherein said locking hole set is adapted to receive a padlock to secure said stop plate independently of said pinning assembly.
